(19) United States
(12) Patent Application Publication
(10) Pub. No.: US 2007/0205995 A1
(43) Pub. Date: Sep. 6, 2007

(54) SYSTEM FOR PROVIDING TACTILE SENSATION TO A ROBOTIC GRASPING MECHANISM USING CAPACITANCE TOUCHPAD TECHNOLOGY

(76) Inventor: Richard D. Woolley, Orem, UT (US)

Correspondence Address: MORRISS OBRYANT COMPAGNI, P.C., 734 EAST 200 SOUTH, SALT LAKE CITY, UT, 84102, US

(21) Appl. No.: 11/677,497

(22) Filed: Feb. 21, 2007

Related U.S. Application Data
(60) Provisional application No. 60/775,427, filed on Feb. 21, 2006.

(51) Int. Cl. G06F 3/041

(52) U.S. Cl. 345/173

(57) ABSTRACT

A capacitance sensitive touchpad, wherein X and Y electrode grids are separated by a resilient but deformable material, such as a gel or other rubber-like material, wherein an object coming into contact with the touchpad causes the resilient material between the electrode grids to be compressed, and wherein the touchpad is capable of determining the change in distance between the electrode grids and thereby determine the amount of force being applied to the touchpad to cause the detected compression of the resilient material.

### BACKGROUND OF THE INVENTION

1. Field of the Invention

This invention relates generally to tactile sensing systems and robotic devices. More specifically, the present invention enables a robotic system to have the ability to grasp and manipulate objects by utilizing touchpad technology to provide tactile feedback.

2. Description of Related Art

For years, engineers have been designing tactile sensing systems to enable robotic “hands” to grasp and manipulate objects. For example, there are many industrial applications where objects need to be manipulated during assembly line construction. The automobile industry is a good example. Industrial robots lift and move automobile components so that a frame can be assembled as it moves along an assembly line.

There are applications within and without industry where the ability for a machine to sense and more carefully grasp and move objects can be exploited. While systems do exist that enable a robotic “hand” to sense how much pressure is being applied to a particular object within its grasp, these systems are generally complicated, expensive, or do not do an adequate job.

It would be an advantage over the state of the art in robotic sensing technology to provide a simple, inexpensive, and robust system for providing tactile feedback.

An important aspect of the present invention is the use of capacitance sensing technology for tactile sensing. Touchpad technology by CIRQUE® Corporation has been adapted to perform this function. Accordingly, it is useful to understand at least one embodiment of this touchpad technology. However, it should be remembered that the touchpad technology may be further modified for this particular invention.

The CIRQUE® Corporation touchpad is a mutual capacitance-sensing device and an example is illustrated in FIG. 1. In this touchpad, a grid of row and column electrodes is used to define the touch-sensitive area of the touchpad. Typically, the touchpad is a rectangular grid of approximately 16 by 12 electrodes, or 8 by 6 electrodes when there are space constraints. Interlaced or otherwise disposed within or around these row and column electrodes is a single sense electrode. All position measurements are made through the sense electrode.

In more detail, FIG. 1 shows a capacitance sensitive touchpad 10 as taught by CIRQUE® Corporation includes a grid of row (12) and column (14) (or X and Y) electrodes in a touchpad electrode grid. All measurements of touchpad parameters are taken from a single sense electrode 16 also disposed on the touchpad electrode grid, and not from the X or Y electrodes 12, 14. No fixed reference point is used for measurements. A touchpad sensor circuit 20 generates signals from P,N generators 22, 24 that are sent directly to the X and Y electrodes 12, 14 in various patterns. Accordingly, there is a one-to-one correspondence between the number of electrodes on the touchpad electrode grid, and the number of drive pins on the touch sensor circuitry 20.

The touchpad 10 does not depend upon an absolute capacitive measurement to determine the location of a finger (or other capacitive object) on or in proximity to the touchpad surface. Hereinafter it should be assumed that the touchpad of the present invention is capable of touch and/or proximity sensing whenever contact is being described with the touchpad.

The touchpad 10 measures an imbalance in electrical charge to the sense line 16. When no pointing object is on the touchpad 10, the touch sensor circuitry 20 is in a balanced state, and there is no signal on the sense line 16. There may or may not be a capacitive charge on the electrodes 12, 14. In the methodology of CIRQUE® Corporation, that is irrelevant. When a pointing device creates imbalance because of capacitive coupling, a change in capacitance occurs on the plurality of electrodes 12, 14 that comprise the touchpad electrode grid. What is measured is the change in capacitance, and not the absolute capacitance value on the electrodes 12, 14. The touchpad 10 determines the change in capacitance by measuring the amount of charge that must be injected onto the sense line 16 to reestablish or regain balance on the sense line.

The touchpad 10 must make two complete measurement cycles for the X electrodes 12 and for the Y electrodes 14 (four complete measurements) in order to determine the position of a pointing object such as a finger. The steps are as follows for both the X 12 and the Y 14 electrodes:

First, a group of electrodes (say a select group of the X electrodes 12) are driven with a first signal from P, N generator 22 and a first measurement using mutual capacitance measurement device 26 is taken to determine the location of the largest signal. However, it is not possible from this one measurement to know whether the finger is on one side or the other of the closest electrode to the largest signal.

Next, shifting by one electrode to one side of the closest electrode, the group of electrodes is again driven with a signal. In other words, the electrode immediately to the one side of the group is added, while the electrode on the opposite side of the original group is no longer driven.

Third, the new group of electrodes is driven and a second measurement is taken.

Finally, using an equation that compares the magnitude of the two signals measured, the location of the finger is determined with a high degree of precision.

Accordingly, the touchpad 10 measures a change in capacitance in order to determine the location of a finger. All of this hardware and the methodology described above assume that the touch sensor circuit 20 is directly driving the electrodes 12, 14 of the touchpad 10. Thus, for a typical 12×16 electrode grid touchpad, there are a total of 28 pins (12+16=28) available from the touch sensor circuitry 20 that are used to drive the electrodes 12, 14 of the electrode grid.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes on the same rows and columns, and other factors that are not material to the present invention.

Although the CIRQUE® Corporation touchpad described above uses a grid of X and Y electrodes and a separate and single sense electrode, the sense electrode can be eliminated, and its function performed by the X or Y electrodes through the use of multiplexing of signals. Either design will enable the present invention to function.

### BRIEF SUMMARY OF THE INVENTION

It is an object of the present invention to provide a system for tactile feedback that utilizes capacitive touchpad technology.

In a preferred embodiment, the present invention is a capacitance sensitive touchpad, wherein X and Y electrode grids are separated by a resilient but deformable material, such as a gel or other rubber-like material, wherein an object coming into contact with (or in proximity of) the touchpad causes the resilient material between the electrode grids to be compressed, and wherein the touchpad is capable of determining the change in distance between the electrode grids and thereby determine the amount of force being applied to the touchpad to cause the detected compression of the resilient material.

In a first aspect of the present invention, an outer electrode grid, which can be either the X or the Y electrodes, is protected by a covering that prevents penetration of the outer electrode grid by objects that are being touched.

In a second aspect of the present invention, the electrode grids are placed at locations near the surface of a mechanical device that are likely to come into contact with other objects.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective diagram of the components of a single capacitance-sensitive touchpad.

FIG. 2 is a cross-sectional view of the layers of materials used in one embodiment of a tactile sensing system of the present invention.

FIG. 3 is a cross-sectional view of the layers of materials used in an alternate embodiment of the tactile sensing system of the present invention.

FIG. 4 is a cross-sectional view of the layers of materials used in an alternate embodiment of the tactile sensing system of the present invention.

FIG. 5 is a perspective view of the tactile sensing system disposed within a single finger of a robotic grasping mechanism.

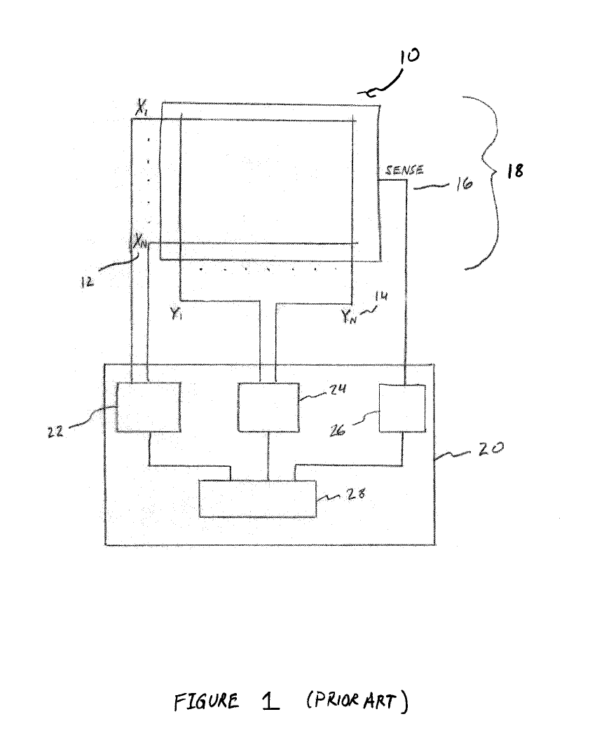

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

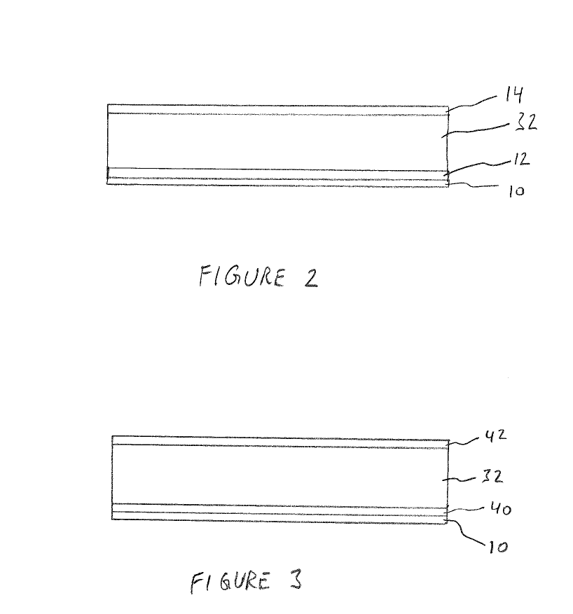

In a first aspect of the present invention, FIG. 2 is a cross-sectional view (not to scale) of a tactile sensing system that is comprised of X-Y electrode grids of a capacitance sensitive touchpad. An outer covering 30 or “skin” is disposed against a surface of an outer electrode grid 12. The outer electrode grid 12 is either an X or a Y electrode (with respect to its counterpart) and is an electrode grid that is part of the X-Y array of electrodes manufactured by CIRQUE® Corporation and described in the Background section. The outer electrode grid 12 also includes touchpad circuitry (not shown) that enables the combination of the outer electrode grid 12 and an inner electrode grid to, in combination, locate and determine the location of an object that is touching or in close proximity to the surface of the outer electrode grid 12.

The next layer in the tactile sensing system of the present invention is a layer of at least one deformable and compressible material 32. It is noted that more than one material may be inserted at this location in the tactile sensing system. The deformable and compressible material 32 prevents the outer electrode grid 12 from making contact with the next layer of the tactile sensing system, the inner electrode grid 14. The deformable and compressible material 32 allows the outer electrode grid 12 to approach the inner electrode grid 14 where force is being applied to the outer covering 10.

It is most likely the case that when an object is in contact with the outer covering 10, that there will be a single point across the outer electrode grid 12 where the greatest force is being applied. Thus, the touchpad 18 formed by the outer electrode grid 12 and the inner electrode grid 14 will usually only need to determine the one location where the touchpad 18 is being forced together and thus have a closest approach relative to each of the outer and inner electrode grids 12, 14.

However, in an alternative aspect of the present invention, it is observed that capacitance sensitive touchpad 18 can be programmed to search for multiple points of contact or proximity. Thus, it is another aspect of the present invention that the touchpad 18 of the present invention is capable of locating multiple locations between the inner and outer electrode grids 12, 14 where the touchpad 18 is being forced closer together by deforming the material 32.

While one of these locations will most likely have the greatest force being applied to it, it may be useful to be able to determine other locations, and thereby determine characteristics of the object exerting a force on the outer covering 10. For example, the object may be rough and covered with a plurality of protrusions that are causing multiple points of compression of the resilient material 32 between the outer and inner electrode grids 12, 14. Thus, the tactile sensing system 8 can determine not only a general shape of an object, but very specific information about the shape.

It has been stated that the tactile sensing system 8 can be used to determine the amount of force being exerted on the outer covering 10. It is worth mentioning at this point that this statement can be applied in the reverse and is equally applicable. In other words, it is also possible to state that the tactile sensing system can be used to determine the amount of force being exerted by the outer covering 10 on an object. Thus, whether the touchpad 18 is being moved so as to touch another object, or another object is being moved into contact with the touchpad, the tactile sensing system works the same.

In another aspect of the present invention, it is observed that by determining the distance between the outer and inner electrode grids 12, 14, coupled with a knowledge of the compressibility of the deformable and compressible material 32, this makes it possible to determine to a high degree of precision the amount of force being applied to the outer covering 10.

The embodiment of the present invention described above is derived from two electrode grids being separated by the resilient material 32. However, in an alternate embodiment as shown in FIG. 3, it is noted that the present invention may be implemented using two touchpads 40 and 42.

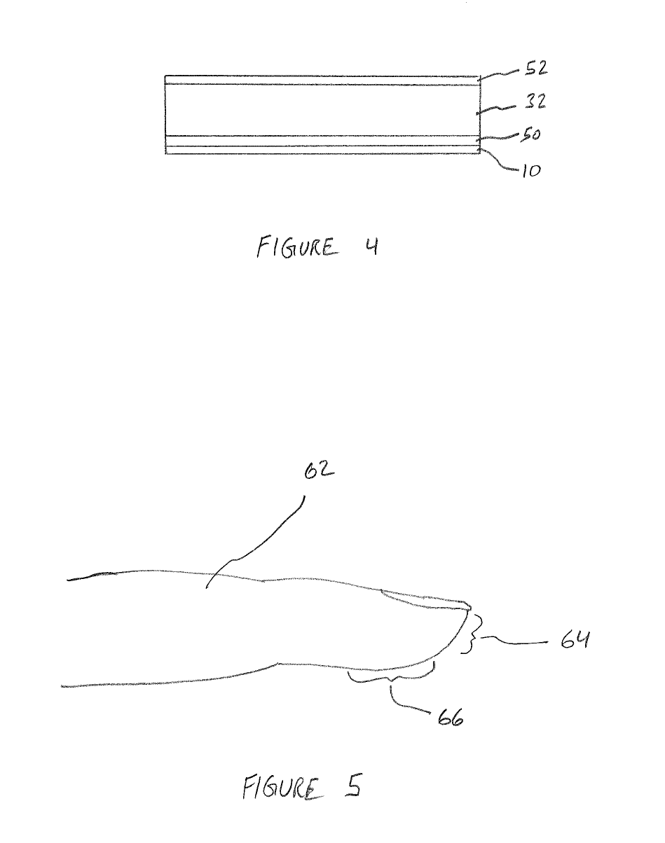

Alternatively, the present invention can be implemented as shown in FIG. 4 by using a sheet of material 50 that is detectable by a single touchpad 52. The sheet of material 50 is disposed adjacent to the outer covering 10. The sheet of material 50 is then moved toward the touchpad 52 by a force exerted on the outer covering 10. Alternatively, the outer covering can be the sheet of material 50 that is detectable by the single touchpad 52. Alternatively, the touchpad is the outer material, and the detectable sheet 50 is the inner material.

FIG. 5 is provided as a profile perspective view of the tactile sensing system disposed within a single artificial finger 62 of a robotic grasping mechanism. The tactile sensing system will be disposed directly beneath an area of the artificial finger 62 that is most likely to make contact with other objects. For example, the tactile sensing system may be disposed under a finger tip 64 and/or a finger pad 66.

Regarding the compressible and deformable material 32 disposed between the outer touchpad and the inner touchpad, this material can be selected from among materials that provide a consistent ability to retain an original shape. In this manner, whenever a force is applied to the outer touchpad causing the material to be compressed, it will always substantially return to its original shape to thereby maintain a constant distance between the touchpads.

Some materials that may be suitable as the compressible and deformable material may be selected from gels, rubber and rubber-like materials, solid foams, open-cell foams, closed-cell foams, and similar materials. In other words, any suitable material can be used that exhibit a property of returning to an original shape after being deformed by application of force after the force is removed

It is envisioned that it may be necessary to provide a calibration scheme in order to compensate for changes in the distance between the outer and inner electrode grids 12, 14 that may take place over time. The change may come about due to the breakdown of the compressible and deformable material 32, or other reasons. The calibrations scheme would simply enable the touchpad 18 to “zero-out” and compensate for a permanent deformation in the compressible and deformable material 32.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A tactile sensing system utilizing touchpad technology, said system comprised of:
an outer electrode grid;
an inner electrode grid;
at least one compressible material disposed between the outer electrode grid and the inner electrode grid; and
a control system in communication with the outer electrode grid and the inner electrode grid, wherein the control system determines a force applied to the outer electrode grid by measuring a change in distance between the outer electrode grid and the inner electrode grid when the at least one compressible material is deformed.

2. The system as defined in claim 1 wherein the system is further comprised of an outer covering disposed adjacent to the outer electrode grid to thereby form a protective layer to prevent damage to the outer electrode grid.

3. The system as defined in claim 1 wherein the at least one compressible material is selected from the group of compressible materials comprised of a gel, rubber, rubber-like material, solid foam, open-cell foam, and closed-cell foam, and materials that exhibit a property of returning to an original shape after being deformed by application of force after the force is removed.

4. The system as defined in claim 1 wherein the system is further comprised of a plurality of independently operating tactile sensing systems.

5. The system as defined in claim 4 wherein the system is further comprised of a sensing object, wherein the sensing object includes the plurality of independently operating tactile sensing systems disposed at various locations therein, such that the sensing object can determine from which direction an object is touching the sensing object.

6. The system as defined in claim 1 wherein the system is further comprised of a calibration means for calibrating operation of the control system to thereby compensate for changes in the outer electrode, the inner electrode, and the at least one compressible material.

7. The system as defined in claim 1 wherein the control system is further comprised of means for determining a degree of force applied to the tactile sensing system.

8. A method for providing tactile feedback to a mechanical system, said method comprising the steps of:
(1) providing an outer electrode grid, and inner electrode grid, and at least one compressible material disposed between the outer electrode grid and the inner electrode grid; and
(2) providing a control system that receives data from the outer electrode grid and the inner electrode grid, wherein the control system determines a change in distance between the outer electrode grid and the inner electrode grid to thereby determine if a force is being applied to the outer electrode grid.

9. The method as defined in claim 8 wherein the method further comprises the step of providing an outer covering disposed adjacent to the outer electrode grid to thereby form a protective layer to prevent damage to the outer electrode grid.

10. The method as defined in claim 8 wherein the method further comprises the step of selecting the at least one compressible material from the group of compressible materials comprised of a gel, rubber, rubber-like material, solid foam, open-cell foam, and closed-cell foam, and materials that exhibit a property of returning to an original shape after being deformed by application of force after the force is removed.

11. The method as defined in claim 8 wherein the method further comprises the step of providing a plurality of independently operating tactile sensing systems on a sensing object to thereby enable the single sensing object to detect touch on a plurality of different locations on the sensing object.

12. The method as defined in claim 8 wherein the method further comprises the step of calibrating the control system to thereby compensate for changes in the outer electrode, the inner electrode, and the at least one compressible material.

13. The method as defined in claim 8 wherein the method further comprises the step of determining a degree of force applied to the tactile sensing system.

14. A tactile sensing system utilizing touchpad technology, said system comprised of:
An outer touchpad;
An inner touchpad;
at least one compressible material disposed between the outer touchpad and the inner touchpad; and
a control system in communication with the outer touchpad and the inner touchpad, wherein the control system determines a force applied to the outer touchpad by measuring a change in distance between the outer touchpad and the inner touchpad when the at least one compressible material is deformed.

15. A tactile sensing system utilizing touchpad technology, said system comprised of:
an outer detectable sheet;
an inner touchpad;
at least one compressible material disposed between the outer detectable sheet and the inner touchpad; and
a control system in communication with the inner touchpad, wherein the control system determines a force applied to the outer detectable sheet by measuring a change in distance between the outer detectable sheet and the inner touchpad when the at least one compressible material is deformed.
